(19) United States
(12) Patent Application Publication
(10) Pub. No.: US 2007/0296245 A1
(43) Pub. Date: Dec. 27, 2007

(54) Sliding Door For A Motor Vehicle

(76) Inventors: Olaf Kriese, Lautertal (DE); Patricia Cruz, Bamberg (DE); Hilmar Dohles, Itzgrund (DE); Rolf Bucker, Bamberg (DE); Ronny Schreiber, Floh-Seligenthal (DE); Manfred Stenzel, Bamberg (DE)

Correspondence Address: CHRISTIE, PARKER & HALE, LLP, PO BOX 7068, PASADENA, CA, 91109-7068, US

(21) Appl. No.: 11/667,391

(22) PCT Filed: Dec. 29, 2005
(86) PCT No.: PCT/DE05/02337

§ 371 Date: May 8, 2007

(30) Foreign Application Priority Data
Jan. 14, 2005 (DE) 10 2005 001 776.2

(51) Int. Cl. E05F 15/14; E05B 65/12

(52) U.S. Cl. 296/155; 49/360; 70/237

(57) ABSTRACT

A sliding door for a motor vehicle which may be moved along a direction of displacement for opening and closing a door opening in the motor vehicle body is provided. The sliding door comprising a sliding door drive for producing a drive torque, a force transmitting mechanism and at least one further device for actuating an adjusting part of the sliding door. At least parts of the sliding door drive and parts of the further device for actuating an adjusting part have been pre-assembled on a module support outside the sliding door and the module support is arranged and secured as a pre-constructed module to the sliding door, together with the parts pre-assembled thereon outside the sliding door.

### CROSS-REFERENCE TO A RELATED APPLICATION

This application is a National Phase Patent Application of International Patent Application Number PCT/DE2005/002337, filed on Dec. 29, 2005, which claims priority of German Patent Application Number 10 2005 001 776.2, filed on Jan. 14, 2005.

### BACKGROUND

The invention relates to a sliding door for a motor vehicle.

Such a sliding door may be moved by displacement along a motor vehicle body, in order to be able to open and close a door opening of the motor vehicle body. To this end, said sliding door comprises a sliding door drive, in particular in the form of an electromotive drive with a gear mechanism arranged downstream, which may be connected to a stationary part of the motor vehicle body, i.e. a part which is not able to be moved with the sliding door, via a force transmitting mechanism. This may, therefore, be a control cable guided in a Bowden sheath, for example. The adjusting forces produced by the sliding door drive may, therefore, be transmitted between the sliding door and the motor vehicle body, in order to produce the desired relative movement of the sliding door relative to the motor vehicle body, i.e. to effect a displacement of the sliding door. Such a sliding door generally has further devices for actuating an adjusting part, for example a door lock for actuating such lock parts which effect a locking or unlocking of the sliding door, as well as a window winder for adjusting the position of an adjustable window.

### SUMMARY

The problem of the invention is to provide a sliding door of the aforementioned type which is characterized by improved and variable ease of assembly.

According to the invention, a module support is provided which may be fastened to the sliding door and which, in addition to the sliding door drive, carries at least a proportion of the components of at least one further device, for actuating an adjusting part, i.e. for example components of the closure system (door lock and possibly a door closing aid) and/or components of a window winder for adjusting a window.

By means of the solution according to the invention, integrated modular subsystems for sliding doors are produced which may be pre-assembled outside the sliding door and tested for their function and which may be fastened to the sliding door as completely pre-constructed and pre-tested modules.

In this connection, the sliding door drive may either be fastened directly to the module support or alternatively merely connected to the module support via the force transmitting mechanism, for example in the form of a flexible shaft or in the form of a control cable with a Bowden sheath.

Provided that the module support carries a door lock as a further device for actuating an adjusting part, a corresponding lock support is provided, in particular integrally formed, on the module support. The door lock may, therefore, be mounted to be displaceable in one direction on the module support for the purposes of tolerance compensation. Furthermore, the lock support may itself also be displaceable relative to other regions of the module support, for example by the lock support being connected to the further regions of the module support via a deformable portion.

Provided that the module support carries components of a window winder for actuating an adjustable window, as a further device for actuating an adjusting part, the adjusting drive of the window winder and/or a guide rail for guiding the window to be adjusted may be provided on the module support. The guide rail may, in particular, be a rail for guiding a lateral window edge of the window to be adjusted, a corresponding guide channel for guiding the associated lateral window edge of the window being preferably arranged on a module support consisting of plastics. The guide channel is advantageously formed by a plurality of overlap regions arranged one after the other in the direction of adjustment of the window and which respectively overlap the associated lateral window edge in a U-shaped manner.

According to a development of the invention, a further guide rail for guiding the window to be adjusted is provided which may be arranged on a separate module support. According to a preferred embodiment, a carrier is displaceably mounted on the second guide rail in the direction of adjustment and which may be moved by the adjusting drive of the window winder, for example via a flexible traction means, along the second guide rail and which is connected to the window to be adjusted, so that when the carrier is moved the window to be adjusted is carried along.

With a combination of a module support consisting of plastics with a guide rail integrally formed thereon, and a further module support with a second guide rail, the second module support and the second guide rail advantageously consist of a high strength material, in particular steel which, on the one hand, effects a reinforcement of the door body and, on the other hand, allows an arrangement of the second guide rail such that said second guide rail bears a larger proportion of the window load than the first guide rail. To this end, the second guide rail is arranged closer to the center of gravity of the window to be adjusted, i.e.—viewed along the lower edge of the window to be adjusted—closer to the center of the window. The arrangement is preferably carried out such that the second, high strength guide rail bears at least 65% of the window load.

Before or during installation in a sliding door, the two modules may be combined into a structural unit which forms a component of the wet/dry space separation of the sliding door, i.e. separates the dry space facing the vehicle interior from the wet space facing the vehicle exterior. If the two module supports are arranged and fastened separately on the corresponding sliding door with the respective components pre-assembled thereon, this allows a simplified assembly, for example by swinging-in.

Furthermore, deflection elements for the sliding door drive as well as channels, safety and tensioning elements for a traction means (cable) which, as a force transmitting device, is coupled to the sliding door drive or to the adjusting drive of the window winder, may be integrated in one or other module support.

With a portion projecting in the assembled state laterally beyond the door shell of the sliding door, the module support may additionally undertake covering and guiding functions for the force transmitting device of the sliding door drive, for example in the form of a control cable.

### BRIEF DESCRIPTION OF THE DRAWINGS

Further details and advantages of the invention will become clear in the following description of embodiments, with reference to the figures, in which:

FIG. 1 is a schematic view of a sliding door for a motor vehicle with an adjusting system arranged on the door inner skin of the motor vehicle door.

FIG. 1A is a section through a guide rail of the adjusting system of FIG. 1.

FIG. 2 is a view of a sliding door of a motor vehicle with an adjusting system arranged thereon.

FIG. 3 is an adjusting system pre-assembled on a module support for a sliding door of a motor vehicle.

FIG. 4 is a further embodiment of an adjusting system pre-assembled on a module support, for a motor vehicle door.

### DETAILED DESCRIPTION

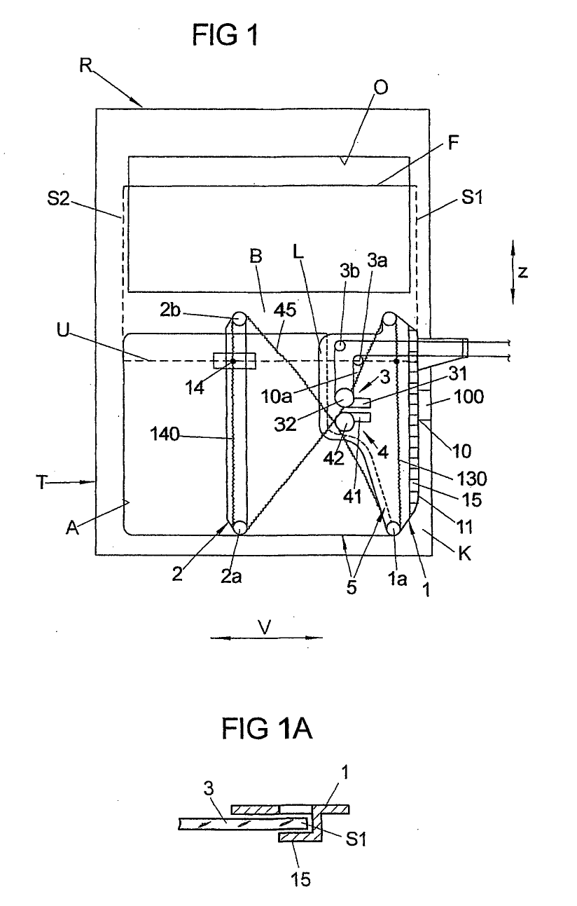

A displaceable sliding door of a motor vehicle is shown in FIG. 1 in a schematic side view along a direction of displacement V. The sliding door comprises a door frame T which is provided with a large detail A on the inside facing the vehicle interior, as well as a window frame R attached to the door frame K toward the top which defines a window opening 0 which may be closed by a window F which may be adjusted by means of a window winder.

The large detail A of the inner skin of the door frame K is covered by two module supports 1, 5 which respectively bear a proportion of the components of an adjusting system of the sliding door. As components, this adjusting system comprises a sliding door drive 3 for displacing the sliding door along the direction of displacement V, a window winder for raising and lowering the window F along a direction of adjustment z as well as a door lock 100 for closing the sliding door.

The first module support 1 firstly comprises, on its lateral edge, a lock support 10 for receiving the door lock 100. Moreover, the first module support 1 forms, on its lateral edge, a guide channel as a guide rail for a lateral window edge S1 of the window F to be adjusted and, namely, by a plurality of overlap regions 15 arranged one after the other in the direction of adjustment z of the window F to be adjusted and which overlap the window F in the region of its associated lateral window edge S1 in a U-shaped manner, see FIG. 1a. A defined guiding of the window F is thereby ensured in the direction of adjustment z.

The guide rail 11 is a component of a window winder for raising and lowering the window F which additionally comprises a second guide rail 2 extended in the direction of adjustment z of the window F to be adjusted and spaced apart from the first guide rail 11 formed by the overlap regions 15 of the first module support 1, perpendicular to the direction of adjustment z. At the upper and lower ends in the direction of adjustment z of the two guide rails 11, 2 are provided respective deflection elements 1a, 1b and/or 2a, 2b in the form of deflection pulleys, by means of which a flexible traction means 45 of the window winder may be deflected such that one respective partial section 130 and/or 140 of the flexible traction means 45 (for example in the form of a cable) extends along the respective guide rail 11 and/or 2.

One respective carrier 13, 14 is connected to the respective traction means portion 130 and/or 140 extended along one of the guide rails 11, 2 which, in the region of the lower window edge U of the window F to be adjusted, is secured thereto. In this connection, the carrier 13 associated with the first guide rail 11 is merely guided loosely along that guide rail 11, whilst the carrier 14 guided along the second guide rail 2 is positively and displaceably engaged with the second guide rail 2 in the direction of adjustment z, i.e. is forcibly guided on the associated guide rail 2.

An adjusting drive 4 is associated with the flexible traction means 45 and which comprises a drive motor 41 and a gear mechanism 42 arranged downstream of the drive motor 41 and which, for example, cooperates in the known manner via a cable drum with the traction means 45, and is able to move said traction means according to the direction of rotation of the drive motor 41 along one or other direction. As a result, the window F connected to the traction means 45 by the carrier 13, 14 is raised or lowered according to the direction of rotation of the motor 41 along its direction of adjustment z.

The adjusting drive 4 is arranged on a partial section 10a of the module support 1 which, at the same time, forms the lateral overlap regions 15 of the first guide rail 11 of the window winder.

The first module support 1 further comprises a lock support 10 for receiving a door lock which is rigidly connected to the module support 1, in particular integrally formed thereon.

Finally, a sliding door drive 3 is also arranged on the module carrier 1 which comprises a motor 31 as well as an adjusting gear mechanism 32 arranged downstream of the motor 31, which drives a traction means 35 which may be guided via deflection elements 3a, 3b in the form of cable pulleys to a region of a motor vehicle body which may not be moved together with the sliding door and may be secured there, so that the traction means 35, as a force transmitting element driven by the sliding door drive 3, serve to transmit adjusting forces between the sliding door and a stationary region of the bodywork of a motor vehicle. As a result, a relative movement of the sliding door is produced relative to the motor vehicle body in the direction of displacement V. Instead of a flexible traction means, any other force transmitting elements may also be used which are suitable for coupling the sliding door drive 3 arranged on the sliding door side to a stationary region of the motor vehicle body.

By means of a portion 12 projecting in the assembled state laterally beyond the door shell of the sliding door, the module support may additionally undertake covering and guiding functions for the force transmitting device of the sliding door drive, for example in the form of a control cable 35.

The first module support 1 preferably consists of a material which facilitates a one-piece incorporation of a lock support 10, lateral overlap regions 15 for the window 3 to be adjusted, as well as, optionally, bearing elements for mounting gear components of the sliding door drive 3 and/or the adjusting drive 4, i.e. in particular made of plastics or optionally a light metal.

The second module support 5 serves for receiving the second guide rail 2 extended in the direction of adjustment z of the window F to be adjusted which, spaced apart from the second lateral edge S2 of the window F, is located markedly closer to the center of gravity—viewed transversely to the direction of adjustment z along the window lower edge U—i.e. markedly closer to the center point of the window F. The second guide rail 2, therefore, during operation of the window winder, as when slamming the corresponding vehicle door shut, bears a markedly larger proportion of the window load than the guide rail 11 integrated in the first module support 1. Advantageously, the arrangement of the two guide rails 11, 2 is such that the second guide rail 2 receives at least 60% and the first guide rail 11 at most 40% of the weight of the window F to be adjusted. Accordingly, the second guide rail 2 advantageously consists of a correspondingly more stable, stronger material than the first guide rail 11, i.e. for example of steel.

The corresponding second module support 5 is also advantageously made from metal, in particular from steel, so that it contributes to the reinforcement, (crash resistance) in particular, of the door body.

The two module supports 1, 5 together completely cover the detail A on the inside of the door frame K and thus ensure a seal of the dry space relative to the wet space of the sliding door. The space which is located on the side of the sliding door facing the vehicle interior is therefore regarded as the dry space, whilst the wet space is located in front of the side of the door inner skin facing the outside.

In the installed state, the two module supports 1, 5 may, on the one hand, be connected to one another in their overlap region L; on the other hand there exists a connection between the two modules of the adjusting system, namely the components of the adjusting system arranged on the first module support 1 and the components of the adjusting system arranged on the second module support 5, via the traction means 45 of the window winder.

The deflection elements 1b, 2b in the form of deflection pulleys provided at the upper ends of the guide rails 1, 2, are also respectively fastened to the parapet region of the sliding door, so that forces of the traction means 45 acting at that point may be introduced directly into the motor vehicle body. In contrast, the lower deflection elements 1a, 2a in the form of deflection pulleys are fastened, in the embodiment, to the respective guide rail 11 and/or 2 as well as to the corresponding module support 1 and/or 5.

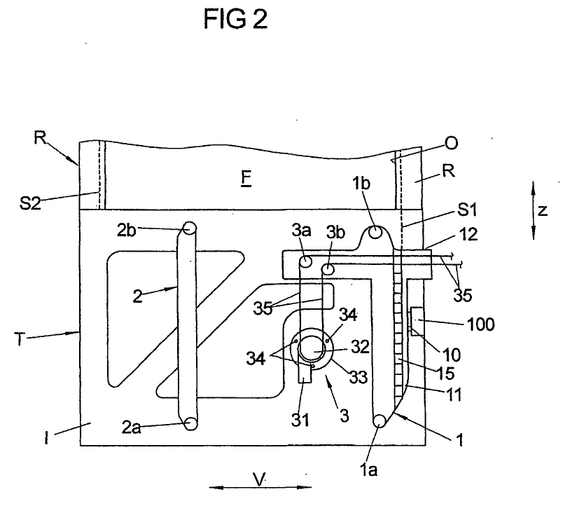

FIG. 2 shows a modification of the arrangement of FIG. 1, in which the first module 1 again comprises an integrally formed first guide rail 11 which is formed by a plurality of overlap regions 15 arranged one after the other in the direction of adjustment z of the window F to be adjusted and overlapping a lateral window edge S1 of the window F to be adjusted. On the first module support 1, a lock support 10 is formed which bears the door lock 100.

In contrast to the embodiment shown in FIG. 1, however, the sliding door drive 3 is not arranged on the first module support 1 but is connected to said module support merely via a force transmitting element formed by a flexible traction means 35. The sliding door drive 3 comprises a drive motor 31 and a gear mechanism 32 arranged downstream as well as a fastening flange 33 with a plurality of fastening points 34, via which the sliding door drive 3 is fastened directly to the door inner skin 1 of the sliding door.

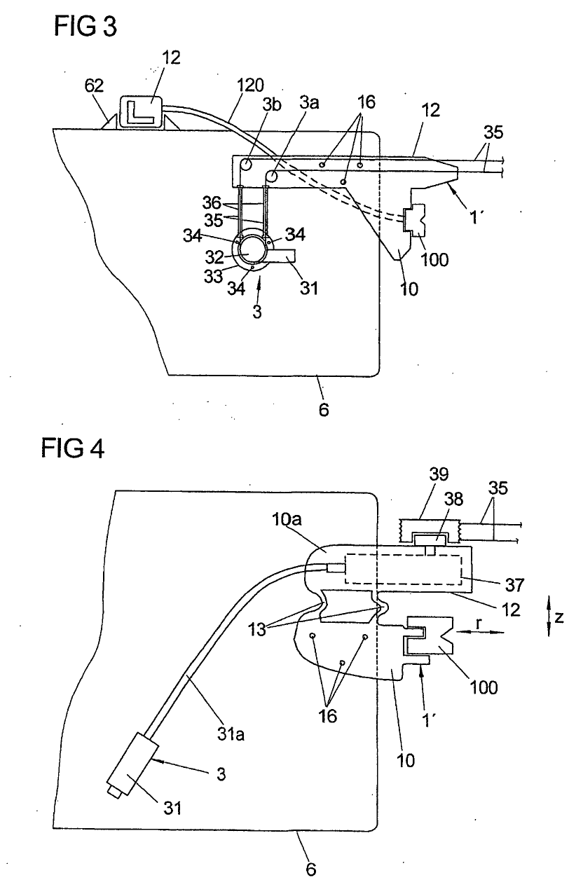

In contrast to the adjusting system shown in FIG. 1, the sliding door drive 3 is not, therefore, in this case directly secured to the first module support 1 but the sliding door drive is merely connected to the module support 1 via the force transmitting element in the form of a traction means 35. However, this also allows the pre-assembly of a module consisting of the window winder 11 formed integrally on the module support 1, the door lock 100 secured on the lock support 10 of the module support 1, as well as the sliding door drive 3 connected to the module support 1 via the flexible traction means 35. The connection of the flexible traction means 35 to the module support 1 is, therefore, carried out via the deflection elements 3a, 3b provided on the module support 1 in the form of deflection pulleys, about which the flexible traction means 35 driven by the sliding door drive 3 is guided. To this end, the traction means 35 is preferably guided in at least one Bowden sheath which, on the one hand, is supported (suspended or fixed in another manner) on the sliding door drive 3 and, on the other hand, on the module support 1, see FIG. 3.

Accordingly, the first module support 1 on the one hand and the sliding door drive 3 on the other hand are fastened independently of one another to the door inner skin 1 of the sliding door. The fastening of the first module support 1 to the door inner skin 1 is carried out by fastening means which penetrate the axes of the deflection elements 1a, 1b in the form of deflection pulleys provided on the first module support 1. In contrast, the fastening of the sliding door drive 3 is carried out in the aforementioned manner via fastening means which penetrate the fastening points 34 in the form of fastening openings provided on the fastening flange 33 of the sliding door drive 3.

The second guide rail 2 of the window winder is also fastened via fastening means to the door inner skin 1 which penetrate the bearing axes of the deflection elements thereof 2a, 2b in the form of deflection pulleys.

Mounting holes visible on the door inner skin 1 are subsequently covered for creating a sealed wet/dry space separation.

In the embodiment shown in FIG. 2, for the sake of simplicity, a proportion of the components of the window winder, namely the adjusting drive thereof, does not show the flexible traction means driven thereby, and the carrier guided by means of the traction means. To this end, reference is made to the view in FIG. 1.

In the embodiment of an adjusting system shown in FIG. 3 a lock support 10 is configured on a module support 1′ on which a door lock 100 is mounted with restricted longitudinal displacement, so that when installing the module in a sliding door, tolerance compensation is possible.

Furthermore, two deflection elements 3a, 3b in the form of deflection pulleys are rotatably mounted on the module support 1′, and which serve for the deflection of a force transmitting element formed by a flexible traction means in the form of a control cable, which cooperates with the gear mechanism 32 of a sliding door drive 3. Associated with the gear mechanism 32, on the one hand, is, in turn, a drive motor 31 and a fastening flange 33, on the other hand, provided with fastening points 34 in the form of fastening openings, via which the sliding door drive 3 may be fastened to an assembly support 6.

The module support 1′ with the lock support 10 and the door lock 100 mounted thereon, as well as with the deflection elements 3a, 3b and the sliding door drive 3 connected thereto via the flexible traction means 35, in turn forms a pre-assembled module, which may be fastened to an assembly support 6 of a sliding door via fastening points 16 provided on the module support 1′, an independent fastening of the sliding door drive 3 being additionally provided via the fastening flange 33 thereof—as disclosed.

The traction means 35 cooperating with the sliding door drive 3 is, therefore, guided in the region between the sliding door drive 3 and the module support 1′ in Bowden sheaths 36 which are secured, for example suspended, to the fastening flange 34 of the sliding door drive 3, on the one hand, and to the module support 1′, on the other hand; a connection between the module support 1′ and the sliding door drive 3 is thereby created, which allows a pre-assembly of the sliding door drive 3 on the module support 1′ before the module support 1′ and the sliding door drive 3 are secured via the fastening points 16 and/or 34 provided therefor on the assembly support 6 of the door inner skin.

A door inner opener 12 also belongs to the components which may be combined on the module support 1′ into an adjusting system which may be pre-assembled, and which is connected, via a force transmitting element 120 in the form of a Bowden cable, to the door lock 100. A receiver 62 for the door inner opener 12 is provided on the assembly support 6 of the sliding door so that, during the assembly of the module support 1′ and the components 3, 3a, 3b, 12, 100 pre-assembled thereon, said assembly support may be inserted into that receiver 62.

In the embodiment shown in FIG. 4 of an adjusting system for a sliding door, a module support 1′ comprises a lock support 10 on which a door lock 100 is mounted, being able to be moved in a displaceable and/or flexible manner along a first direction r and which is provided with fastening points 16 in the form of fastening openings for fastening on an assembly support 6 of a sliding door.

The lock support 10 is connected integrally to a receiving region 10a via two flexible web-like portions 13, on which a gear mechanism 37 of the sliding door drive 3 is mounted. The receiving region 10a may, therefore, comprise housing parts for mounting gear elements of the gear mechanism 37. For the purposes of tolerance compensation, the flexible portions 13 allow a relative movement of the lock support 10 with regard to the receiving region 10a along a direction z, which is oriented perpendicular to the direction r, along which the lock 100 is displaceably mounted on the lock support 10.

The motor 31 of the sliding door drive 3 associated with the gear mechanism 37 is arranged outside the receiving region 10a and may be fastened separately on the assembly support 6. It is connected to the gear mechanism 37 by a flexible shaft 36 and thereby forms a component of the module pre-assembled on the lock support 10 and on the receiving region 10a formed integrally thereon.

The gear mechanism 37 of the adjusting drive 3 drives a drive element 38 in the form of a gearwheel which, in turn, is engaged with an internal toothing of a rotatable cable drum 39, which during operation of the motor 31 of the adjusting drive 3 is rotated via the flexible shaft 36, the gear mechanism 37 arranged downstream and the drive element 38 and about which a force transmitting element 35 in the form of a control cable is wound, which is actuated when the cable drum 39 is rotated, in order to displace the associated sliding door.

1-28. (canceled)

29. A sliding door for a motor vehicle which may be moved along a direction of displacement for opening and closing a door opening in the motor vehicle body, with
a sliding door drive provided on the sliding door for producing a drive torque,
a force transmitting mechanism which, on the one hand, is coupled to the sliding door drive and which, on the other hand, is configured and provided for connecting to a stationary part of a motor vehicle body, in order to effect a movement of the sliding door along the direction of displacement by force transmission between the sliding door and the motor vehicle body, and
at least one further device for actuating an adjusting part of the sliding door, wherein at least parts of the sliding door drive and parts of the further device for actuating an adjusting part have been pre-assembled on a module support outside the sliding door and wherein the module support is arranged and secured as a pre-constructed module to the sliding door, together with the parts pre-assembled thereon outside the sliding door.

30. The sliding door of claim 29, wherein a motor and/or gear elements of the sliding door drive are pre-assembled on the module support.

31. The sliding door of claim 29 or 30, wherein the components of the further device for transmitting forces to the adjusting part are configured on the module support.

32. The sliding door of claim 29, wherein components of the further device for guiding the adjusting part along its direction of adjustment are configured on the module support.

33. The sliding door of claim 29, wherein a door lock is provided on the module support as a further device for actuating an adjusting part.

34. The sliding door of claim 29, wherein components of a window winder as components of a device for actuating an adjustable window are arranged on the module support.

35. The sliding door of claim 34, wherein an adjusting drive of the window winder is provided on the module support.

36. The sliding door of claim 34, wherein a guide rail for guiding the window to be adjusted by means of the window winder is provided on the module support.

37. The sliding door of claim 36, wherein the guide rail is configured for guiding a lateral window edge of the window to be adjusted.

38. The sliding door of claim 36, wherein the guide rail is formed by a plurality of overlap regions arranged one after the other in the direction of adjustment of the window to be adjusted, for a lateral window edge of the window to be adjusted.

39. The sliding door of claim 36, wherein the guide rail is integrally formed on the module support.

40. The sliding door of claim 36, wherein the module support consists of plastics.

41. The sliding door of claim 36, wherein a second guide rail for guiding the window to be adjusted outside the module support is associated with the window winder outside the module support.

42. The sliding door of claim 36, wherein the second guide rail is arranged on a further module support.

43. The sliding door of claim 42, wherein the further module support consists of metal, in particular steel.

44. The sliding door of claim 41, wherein the second guide rail consists of metal, in particular steel.

45. The sliding door of claim 41, wherein the second guide rail positioned relative to the window to be adjusted, such that a larger proportion of the window weight is accumulated thereon than on the first guide rail.

46. The sliding door of claim 45, wherein at least 65% of the window weight is accumulated on the second guide rail.

47. The sliding door of claim 41, wherein a carrier which may be displaced by means of the adjusting drive of the window winder is arranged on the second guide rail which is connected to the window to be adjusted.

48. The sliding door of claim 42, wherein the two module supports are connected to one another and separate the wet space from the dry space of the sliding door.

49. The sliding door of claim 33, wherein the door lock is arranged on a lock support provided on the module support.

50. The sliding door of claim 49, wherein the door lock is mounted with restricted displacement on the lock support for tolerance compensation.

51. The sliding door of claim 49, wherein the lock support is connected to further regions of the module support via an integrally formed, deformable connecting portion or a sliding joint.

52. The sliding door of claim 29, wherein the sliding door drive is connected to the module support via the force transmitting mechanism.

53. The sliding of claim 52, wherein the force transmitting mechanism is formed by a flexible shaft.

54. The sliding door of claim 52, wherein the force transmitting mechanism comprises a flexible traction means.

55. The sliding door of claim 54, wherein the flexible traction means is guided at least in the region between the sliding door drive and the module support in a Bowden sheath.

56. The sliding door of claim 55, wherein the sliding door drive is connected to the module support via the Bowden sheath which, on the one hand, is secured to the adjusting drive and, on the other hand, to the module support.
